(19) United States
(12) Patent Application Publication
(10) Pub. No.: US 2015/0163847 A1
(43) Pub. Date: Jun. 11, 2015

(54) TECHNIQUES FOR MANAGING THE TRANSFER OF A WIRELESS CONNECTION BETWEEN WIRELESS NETWORKS, CHANNELS OR BANDS

(71) Applicants: Srikathyayani Srikanteswara, Hillsboro, OR (US); Bahareh Sadeghi, Portland, OR (US); Ganesh Venkatesan, Hillsboro, OR (US)

(72) Inventors: Srikathyayani Srikanteswara, Hillsboro, OR (US); Bahareh Sadeghi, Portland, OR (US); Ganesh Venkatesan, Hillsboro, OR (US)

(21) Appl. No.: 13/976,981

(22) PCT Filed: Dec. 5, 2011
(86) PCT No.: PCT/US11/63246

§ 371 Date: Aug. 5, 2014

(51) Int. Cl. H04W 76/04; H04W 36/10

(52) U.S. Cl. CPC H04W 76/045; H04W 36/10

(57) ABSTRACT

Techniques for managing the transfer of a wireless connection between wireless networks, channels or bands are described. In some embodiments a method may comprise receiving a request to transfer a wireless connection between the enabling device and a dependent device from a first wireless network to a second wireless network, determining that the dependent device can not initiate a connection in the second wireless network, rejecting the request, and initiating, by the enabling device, the transfer to the second wireless network. Other embodiments are described and claimed.

### BACKGROUND

Wireless communication systems communicate information over a shared wireless communication medium such as one or more portions of the radio-frequency (RF) spectrum. Recent innovations in mobile computing devices and the increased mobility of mobile devices have resulted in increased demands placed on wireless communications systems. Furthermore, the limited range of some wireless communications systems and the near constant connectivity requirements demanded by users, among other factors, are important considerations when implementing wireless communications systems. One particular area that results in increased demands on wireless communications systems is transferring a wireless connection between wireless networks or between wireless channels. A wireless network, for example, may include a limited range of service and moving a mobile device out of range of the wireless network may result in a dropped connection. As the number and type of devices, networks and systems continues to increase, the demands placed on wireless communications systems, such as managing the transition or transfer between wireless networks, channels or bands, continue to increase. Consequently, techniques designed to manage the transfer of a wireless connection between wireless networks, channels or bands are desirable.

### BRIEF DESCRIPTION OF THE DRAWINGS

FIG. 1 illustrates one embodiment of a first communications system.

FIG. 2 illustrates one embodiment of a first logic flow.

FIG. 3A illustrates one embodiment of a second communications system.

FIG. 3B illustrates one embodiment of a third communications system.

FIG. 3C illustrates one embodiment of a transmission diagram.

FIG. 4 illustrates one embodiment of a second logic flow.

FIG. 5 illustrates one embodiment of an article of manufacture.

FIG. 6 illustrates one embodiment of an apparatus.

### DETAILED DESCRIPTION

Various embodiments may be generally directed to techniques to manage the transfer of a wireless connection between wireless networks, channels or bands. Some embodiments may be particularly directed to methods for seamlessly transferring a connection from a wireless fidelity (WiFi) connection to a television white space (TVWS) connection. In one embodiment, a request to transfer a wireless connection between an enabling device and a dependent device from a first wireless network to a second wireless network may be received at an enabling device, a determination may be made that the dependent device can not initiate a connection in the second wireless network, the request may be rejected, and the transfer to the second wireless network may be initiated by the enabling device. Other embodiments are described and claimed.

In telecommunications, white spaces generally refer to frequencies allocated to a broadcasting service that are not used locally. National and international bodies assign different frequencies of the RF spectrum for specific uses, and in most cases license the rights to broadcast over these frequencies. This frequency allocation process creates a band plan, which for technical reasons assigns white space between used radio bands or channels to avoid interference. In various embodiments, while the frequencies are unused, they have been specifically assigned for a purpose, such as a guard band. In many embodiments, however, these white spaces exist naturally between used channels, since assigning nearby transmissions to immediately adjacent channels may cause destructive interference to both.

In addition to white space assigned for technical reasons, there is also unused radio spectrum which has either never been used, or is becoming free as a result of technical changes. In particular, the switchover to digital television (TV) in the United States and elsewhere has freed up large areas between about 50 MHz and 700 MHz. In the United States, the abandoned television frequencies are primarily in the upper UHF “700-megahertz” band. Various proposals, including Institute of Electrical and Electronics Engineers (IEEE) 802.11af, IEEE 802.22 and those from the White Spaces Coalition, have advocated using white spaces left by the termination of analog TV to provide wireless broadband Internet access. As used hereinafter, this white space may be referred to as television white space (TVWS).

Modern wireless communications systems include nodes and other mobile devices with a high degree of mobility. As a result, providing continuous wireless connectivity may be problematic as devices move in and out of range of different wireless networks, bands and channels. To combat this problem, various transfer protocols have been developed to allow for the transfer of wireless connections without a loss in connectivity. For example, the Fast Session Transfer (FST) protocol is a mechanism designed to allow for switching between two different networks or different bands of a network. In some embodiments, for example, a wireless connection may be transferred between WiFi bands like 60 GHz and 5 GHz without interrupting the connection or higher layer applications.

In various embodiments, devices intended to operate in the TVWS band comprise mainly of two types. These types include but are not limited to fixed devices and mobile devices. In some embodiments, to initiate a TVWS connection, devices are required to include geolocation capability and an ability to communicate with a database to identify other transmitters in the area operating in the TVWS, available bands or other relevant connection information. These devices may be referred to interchangeably hereinafter as fixed devices, mode II devices or enabling devices. The mobile devices which do not include geolocation capabilities and/or do not have access to the necessary databases, and as a result are unable to initiate a TVWS connection, may be referred to interchangeably hereinafter as mode I devices or dependent devices. The embodiments are not limited in this context.

In various embodiments, as a result of these TVWS rules and requirements, the FST protocol may not be suitable for transferring connections to a TVWS connection when a dependent device initiates the transfer. For these and other reasons, embodiments described herein provide techniques to manage the transfer of a wireless connection between wireless networks or channels, including but not limited to transferring connections to TVWS. Other embodiments are described and claimed.

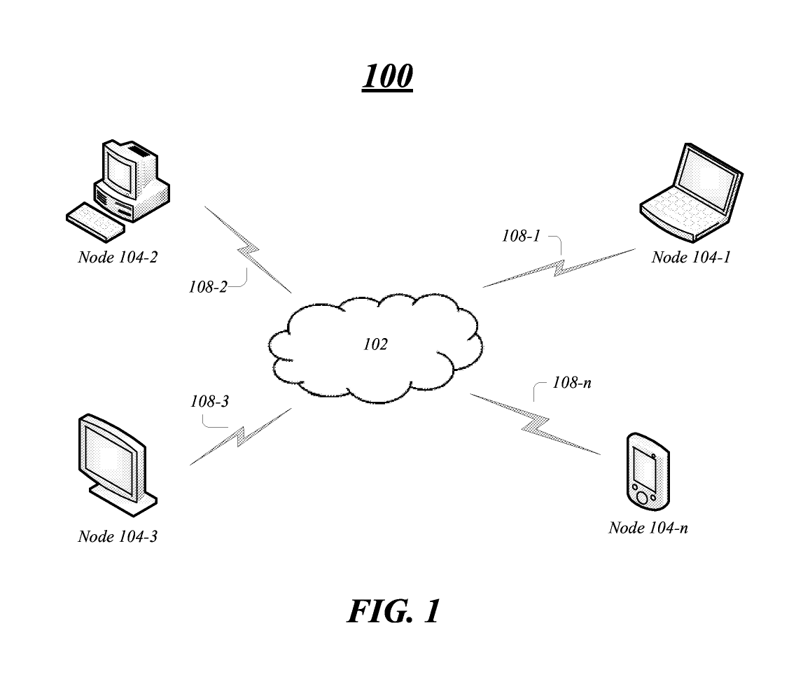

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links. Examples of a wireless communication link may include, without limitation, a radio channel, infrared channel, radio-frequency (RF) channel, WiFi channel, a portion of the RF spectrum, and/or one or more licensed or license-free frequency bands including the TVWS bands.

The communications system 100 may communicate information in accordance with one or more standards as promulgated by a standards organization. In one embodiment, for example, various devices comprising part of the communications system 100 may be arranged to operate in accordance with one or more of the IEEE 802.16 standards for WMAN including standards such as 802.16-2004, 802.16.2-2004, 802.16e-2005, 802.16f, 802.16m, 802.16p progeny and variants; WGA (WiGig) progeny and variants or a 3GPP Long-Term Evolution (LTE) standard. In some embodiments, the communications system 100 may be arranged to communicate in accordance with any fourth generation (4G) network or radio technology progeny and variants.

In various embodiments, the communications system 100 may be arranged to operate in accordance with one or more of the IEEE 802.11 standards, the WiGig Alliance™ specifications, WirelessHD™ specifications, standards or variants, such as the WirelessHD Specification, Revision 1.0d7, Dec. 1, 2007, and its progeny as promulgated by WirelessHD, LLC (collectively referred to as the “WirelessHD Specification”), or with any other wireless standards as promulgated by other standards organizations such as the International Telecommunications Union (ITU), the International Organization for Standardization (ISO), the International Electrotechnical Commission (IEC), the Institute of Electrical and Electronics Engineers (information IEEE), the Internet Engineering Task Force (IETF), and so forth. In various embodiments, for example, the communications system 100 may communicate information according to one or more IEEE 802.11 standards for wireless local area networks (WLANs) such as the information IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11a, b, g/h, j, n, VHT SG, and variants); IEEE 802.15.3 and variants; European Computer Manufacturers Association (ECMA) TG20 progeny and variants; and other wireless networking standards. The embodiments are not limited in this context.

In some embodiments, the communications system 100 may be arranged to operate in accordance with one or more of the IEEE 802.22 standards for Wireless Regional Area Networks (WRAN) using white spaces in the TV frequency spectrum, IEEE 802.11af standards or standards from the White Spaces Coalition. The embodiments are not limited in this context.

The communications system 100 may communicate, manage, or process information in accordance with one or more protocols. A protocol may comprise a set of predefined rules or instructions for managing communication among nodes. In various embodiments, for example, the communications system 100 may employ one or more protocols such as a beam forming protocol, medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), a contention-based period (CBP) protocol, a distributed contention-based period (CBP) protocol and so forth. In various embodiments, the communications system 100 also may be arranged to operate in accordance with standards and/or protocols for media processing. The embodiments are not limited in this context.

As shown in FIG. 1, the communications system 100 may comprise a network 102 and a plurality of nodes 104-1-n, where n may represent any positive integer value. In various embodiments, the nodes 104-1-n may be implemented as various types of wireless devices. Examples of wireless devices may include, without limitation, a station, a subscriber station, a base station, a wireless access point (AP), a wireless client device, a wireless station (STA), a laptop computer, ultra-laptop computer, portable computer, personal computer (PC), tablet computer, notebook PC, handheld computer, personal digital assistant (PDA), cellular telephone, combination cellular telephone/PDA, smartphone, pager, messaging device, media player, digital music player, set-top box (STB), appliance, workstation, user terminal, mobile unit, consumer electronics, television, digital television, high-definition television, television receiver, high-definition television receiver, sensor, meter and so forth.

In some embodiments, the nodes 104-1-n may comprise one more wireless interfaces and/or components for wireless communication such as one or more transmitters, receivers, transceivers, radios, chipsets, amplifiers, filters, control logic, network interface cards (NICs), antennas, antenna arrays, modules and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

In various embodiments, the nodes 104-1-n may comprise or form part of a wireless network 102. In one embodiment, for example, the wireless network 102 may comprise a Worldwide Interoperability for Microwave Access (WiMAX) network. Although some embodiments may be described with the wireless network 102 implemented as a WiMAX wireless network for purposes of illustration, and not limitation, it can be appreciated that the embodiments are not limited in this context. For example, the wireless network 102 may comprise or be implemented as various types of wireless networks and associated protocols suitable for a Wireless Personal Area Network (WPAN), a Wireless Local Area Network (WLAN), a Wireless Metropolitan Area Network, a Wireless Wide Area Network (WWAN), a Broadband Wireless Access (BWA) network, a radio network, a cellular network, a television network, a satellite network such as a direct broadcast satellite (DBS) network, and/or any other wireless communications network configured to operate in accordance with the described embodiments. Other embodiments are described and claimed.

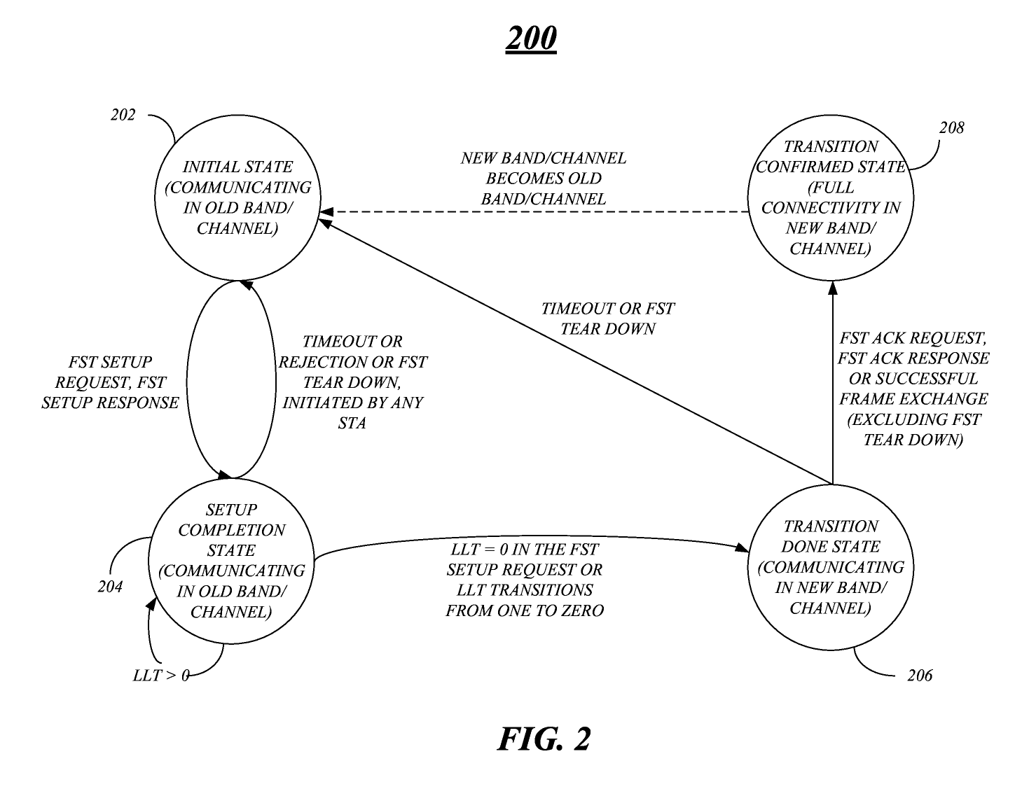

FIG. 2 illustrates a first logic flow 200. As shown in FIG. 2, the first logic flow 200 may represent the steps taken to transfer a wireless connection using the FST protocol. In various embodiments, the FST protocol may comprise a mechanism to switch between two different WiFi bands like 60 GHz and 5 GHz without interrupting the connection or higher layer applications. In some embodiments, two or more devices may initially be communicating in the old channel when one of the devices initiates FST to transfer the connection to another network, channel or band. If the second device accepts the request, the setup for the new channel may be performed in the old channel and the time for transfer may be decided upon. At that decided upon time, the device that initiated the FST protocol may transmit the first frame in the new channel and the second device may respond with an acknowledgement (ACK). As a result, the connection between the devices may be transferred to the new network, channel or band.

In various embodiments, the FST protocol may not be suitable for transitioning a connection from a non-TVWS band like 2.4, 5 or 60 GHz to a TVWS band when initiated by a dependent device. For example, a dependent or mode I device may comprise one which does not have access to a geolocation database and, therefore, needs to be in contact with an enabling or mode II device to maintain transmissions in the TVWS channels. In some embodiments, if a dependent or mode I device initiates FST to a TVWS, it will not be permitted to make the first transmission in the TVWS channel per Federal Communication Commission (FCC) rules because it does not have access to the necessary geolocation database. According to the FCC rules, a dependent or mode I device or any other device that does not have access to the necessary geolocation database cannot transmit in the TVWS channel for the first time until it is enabled by an enabling or mode II device. As a result, based on the current FST protocol scheme, a dependent or mode I device cannot initiate FST to the TVWS frequencies.

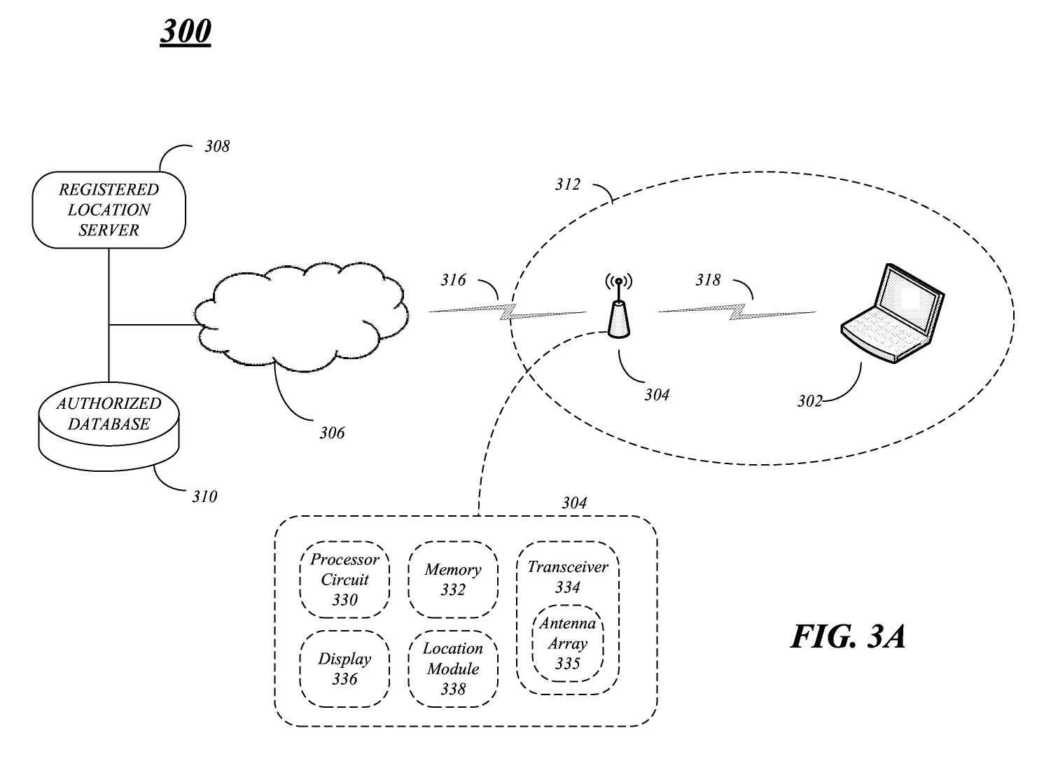

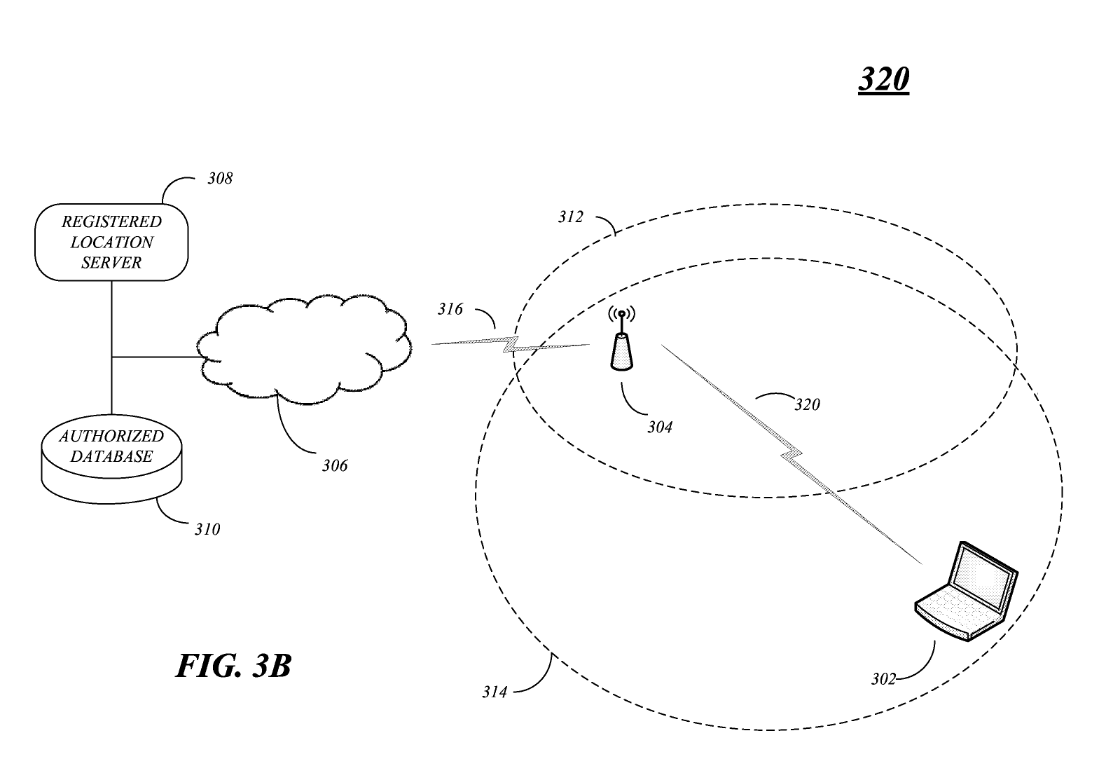

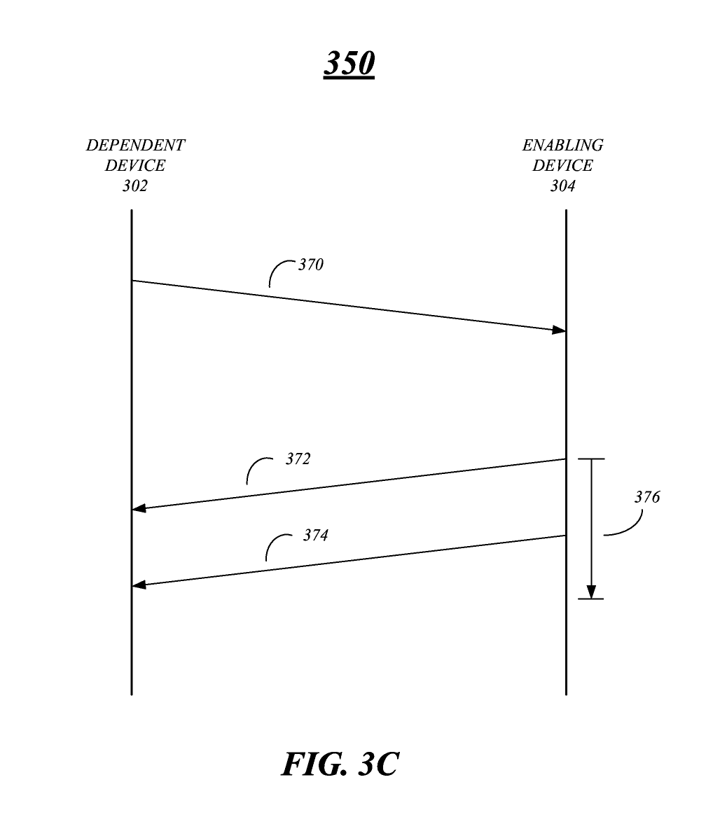

FIG. 3A illustrates a block diagram of one embodiment of a communications system 300. In various embodiments, the communications system 300 may comprise multiple nodes. A node generally may comprise any physical or logical entity for communicating information in the communications system 300 and may be implemented as hardware, software, or any combination thereof, as desired for a given set of design parameters or performance constraints. Although FIG. 3A may show a limited number of nodes by way of example, it can be appreciated that more or less nodes may be employed for a given implementation.

The communications system 300 of FIG. 3A may include dependent device 302, enabling device 304, network 306, registered location server 308, authorized database 310, network 312, connection 314 and connection 316 in some embodiments. An expanded view of enabling device 304 illustrates that this node may include a processor circuit 330, memory 332, transceiver 334, antenna array 335 communicatively coupled to transceiver 334, display 336 and location module 338. While shown as part of enabling device 304, it should be understood that the same or similar components may be present in any of the nodes of communications system 300. The embodiments are not limited to the type, number or arrangement of elements shown in FIG. 3A.

In various embodiments, enabling device 304 and dependent device 302 may comprise devices capable of wireless communication, such as access points, mobile computing devices and the like. In some embodiments, enabling device 304 and dependent device 302 may be in wireless communication or may share a wireless communication connection 318 via wireless network 312. For purposes of illustration, system 300 will be described hereinafter as network 312 comprising a WiFi network. The embodiments are not limited in this context.

As shown in FIG. 3A, enabling device 304 may comprise a processor 330. The processor 330 may be implemented as any processor, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processor 330 may be implemented as a general purpose processor, such as a processor made by Intel® Corporation, Santa Clara, Calif. The processor 330 may also be implemented as a dedicated processor, such as a controller, microcontroller, embedded processor, a digital signal processor (DSP), a network processor, a media processor, an input/output (I/O) processor, and so forth. The processor 330 may have any number of processor cores, including one, two, four, eight or any other suitable number. The embodiments are not limited in this context.

The enabling device 304 may comprise a memory 332 in some embodiments. The memory 332 may comprise any machine-readable or computer-readable media capable of storing data, including both volatile and non-volatile memory. For example, the memory 332 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of the memory 332 may be included on the same integrated circuit as the processor 330, or alternatively some portion or all of the memory 332 may be disposed on an integrated circuit or other medium, for example a hard disk drive, that is external to the integrated circuit of the processor 330. The embodiments are not limited in this context.

As further shown in FIG. 3A, enabling device 304 may comprise a display 336. Display 336 may comprise any suitable display unit for displaying information appropriate for a mobile computing device. In addition, display 336 may be implemented as an additional I/O device, such as a touch screen, touch panel, touch screen panel, and so forth. Touch screens may comprise display overlays which are implemented using one of several different techniques, such as pressure-sensitive (resistive) techniques, electrically-sensitive (capacitive) techniques, acoustically-sensitive (surface acoustic wave) techniques, photo-sensitive (infra-red) techniques, and so forth. The effect of such overlays may allow a display to be used as an input device, to remove or enhance the keyboard and/or the mouse as the primary input device for interacting with content provided on display 336.

In one embodiment, for example, display 336 may be implemented by a liquid crystal display (LCD) or other type of suitable visual interface. Display 336 may comprise, for example, a touch-sensitive color display screen. In various implementations, the display 336 may comprise one or more thin-film transistors (TFT) LCD including embedded transistors. In such implementations, the display 336 may comprise a transistor for each pixel to implement an active matrix. While the embodiments are not limited in this context, an active matrix display may be desirable since it requires lower current to trigger pixel illumination and is more responsive to change than a passive matrix.

In various embodiments, enabling device 304 may communicate information over wireless shared media, connections 316, 318 or network 312 via transceiver 334. The wireless shared media, connections 316, 318 and network 312 may comprise one or more allocations of RF spectrum. The allocations of RF spectrum may be contiguous or non-contiguous. In some embodiments, the transceiver 334 may communicate information over the wireless shared media, connections 316, 318 or network 312 using various multicarrier techniques utilized by, for example, WiFi or WiMAX systems. For example, the transceiver 334 may utilize various techniques to perform beamforming, spatial diversity or frequency diversity.

In some embodiments, enabling device 304 may include location module 338. Location module 338 may comprise logic, hardware, software or a combination of hardware and software than enable enabling device 338 to determine its real world geographic location or position (e.g. geolocation). Although not limited in this context, in some embodiments location module 338 may comprise a global position system (GPS) device or module. Other embodiments are described and claimed.

Enabling device 304 may comprise a node, station or other device that has the authority to control when and how dependent device 302 can operate in some embodiments. For example, enabling device 304 may be operative to transmit an enabling signal to dependent device 302 over the wireless channel 318 in which the dependent device 302 is allowed to operate. In various embodiments, enabling device 304 may choose for dynamic station enablement (DSE) messages to be exchanged over the air, over a distribution system (DS) or by mechanisms that rely on transport via higher layers.

In some embodiments, enabling device 304 may comprise a device that is capable of using an internal geolocation capability (e.g. location module 338) and has access to a TV bands database either through a direct connection or through an indirect connection to obtain a list of available channels in the TVWS. In various embodiments, enabling device 304 may be operative to provide a list of available channels to dependent device 302.

Dependent device 302 may comprise a station, node or other device that is not registered (e.g. not registered with the FCC) and whose operation parameters are dictated by messages it receives from an enabling device, such as enabling device 304 in some embodiments. Once enabled, continued operation of dependent device 302 is contingent upon being able to continue to receive messages from its enabling device. In various embodiments, dependent device 302 does not use or does not have access to an internal geolocation capability and/or access to a TV bands database to obtain a list of available channels. As a result, dependent device 302 must obtain a list of available channels on which it may operate from enabling device 304. Based on the lack of channel access and/or lack of geolocation capabilities, dependent device 302 may not initiate a network or connection in the TVWS.

In general operation, enabling device 304 may comprise a system or apparatus including a processor or processor circuit 330 configured or operative to receive a request from a wireless device to transfer a wireless connection between the apparatus and the wireless device from a first wireless network to a second wireless network. For example, enabling device 304 may share a wireless connection 318 with dependent device 302 via network 312. In some embodiments, as shown in FIG. 3B which may comprise a wireless system 320 that may the same or similar to wireless system 300 where like elements are similarly numbered, dependent device 302 may move out of range of wireless network 312. As shown in FIG. 3B, a new wireless connection 320 may need to be established between dependent device 302 and enabling device 304 via network 314. While shown as different networks and different connections in systems 300 and 320, it should be understood that networks 312 and 314 and connections 318 and 320 may comprise the same network that utilizes a different channel or band or a transferred connection that enables continuous connectivity between enabling device 302 and dependent device 302. The embodiments are not limited in this respect.

In various embodiments, dependent device 302 may send and enabling device 304 may receive a request to transfer connection 318 from network 312 to connection 320 of network 314. In some embodiments, processor or processor circuit 330 of enabling device 304 may be configured or operative determine that the wireless device (e.g. dependent device 302) can not initiate a connection in the second wireless network 314 or the second connection 320, reject the request, and initiate the transfer to the second wireless network 314 or second connection 320. For example, in various embodiments dependent device 302 may request to transfer connection 318 from network 312 to a TVWS channel or band. However, because dependent device 302 does not include geolocation capabilities and/or does not have access to the necessary databases (e.g. 308, 310), dependent device 302 is unable to initiate a TVWS connection. In this example, enabling device 304 may be aware of the capabilities (or lack of capabilities) of dependent device 302 and the limitations imposed on initiating TVWS connections, and may reject the request to transfer connection 318 to a TVWS connection.

In some embodiments, the processor or processor circuit 330 may be operative to send rejection information to the wireless/dependent device 302. For example, the rejection information may comprise a notification of the rejected request. In some embodiments, the rejection notification may also service as a request from the enabling device 304 to initiate a connection because the dependent device 302 is unable to initiate the connection. This information may also be referred to hereinafter as transfer information.

In various embodiments, the rejection and/or transfer information may include status code information, time-to-start information and any other relevant information. In some embodiments, enabling device 304 may respond to the transfer initiation request with a status code 90. The response may also include time-to-start information in various embodiments. For example, the time-to-start may include a time period during which the enabling device 304 is committing to initiating the FST protocol to transfer the wireless connection between the enabling device 304 and the dependent device 302. In some embodiments, the rejection information, transfer information and any other necessary singling or information may be communicated between the enabling device 304 and the dependent device using the first connection 318 or network 312 (e.g. the first wireless network, channel or band). For example, the first wireless network may comprise a wireless local area network (WLAN) operative to utilize protocols compatible with an Institute of Electrical and Electronics Engineers (IEEE) 802.11 standard in some embodiments. In various embodiments, the first wireless network may comprise a WiFi network. The embodiments are not limited in this context.

The processor or processor circuit 330 may be operative to initiate and establish a connection 230 between the apparatus/enabling device 304 and the wireless/dependent device 302 over the second wireless network 314. For example, after using the first wireless network (e.g. connection 318 or network 312), enabling device may initiate and establish a connection 320 using network 314 at the time communicated in the time-to-start information. In some embodiments, the second wireless network 314 or connection 320 may comprise a wireless network, band or channel operative to utilize one or more frequencies allocated to a broadcasting service that is not used in the area of the enabling device. For example, the second wireless network may comprise a wireless network operative to utilize (TVWS) frequencies. Other embodiments are described and claimed.

In various embodiments, the processor or processor circuit 330 may be operative to determine a location of the apparatus or system (e.g. enabling device 304). For example, in some embodiments, enabling device may include location module 338 (e.g. GPS) to determine its geographic location. In other embodiments, enabling device 304 may be operative to access registered location server 308 which may contain a registered location for enabling device 304.

In some embodiments, the processor or processor circuit 330 may be operative to identify available channels in the second wireless network based on the location and a channel database accessed by the apparatus/enabling device 304. For example, enabling device 304 may be operative to access an authorized database 310 that contains information about available channels, bands, network or frequencies in the area of enabling device 304. In some embodiments, based on this information, enabling device 304 may be operative to establish a connection between the apparatus/enabling device 304 and the wireless/dependent device 302 using one or more available channels of the second wireless network as identified by the collected information.

As shown in FIG. 3A, enabling device may include transceiver 334 and antenna array 335 in some embodiments. In various embodiments, the transceiver 334 may comprise one or more radio frequency (RF) transceivers coupled to the processor circuit 330 and operative to send and receive electromagnetic representations of information between the apparatus/enabling device 304, wireless/dependent device 302, network 306 and any other compatible communications device or system. In some embodiments, enabling device 304 and dependent device 302 may include matching antenna arrays 335 and or transceivers 335 for the different wireless connections 318, 320 or networks 312, 314. The embodiments are not limited in this respect.

FIG. 3C illustrates an example transmission diagram 350 for wireless communication systems, such as systems 100, 300 and 320. As shown in FIG. 3C, similar messaging as that described with reference to FIGS. 3A and 3B may be performed between dependent device 302 and enabling device 304. While a limited number and type of messages are described for purposes of illustration, one skilled in the art will appreciate that any number, type or order of messages could be used and still fall within the described embodiments.

In various embodiments, dependent device may send message 370 to enabling device 304. In some embodiments, message 370 may comprise a request to transfer a wireless connection, such as a WiFi connection, to a TVWS connection. In response, enabling device may send message 372 to dependent device 302. In various embodiments, message 372 may comprise a rejection of the request included in message 370. For example, enabling device may known or may determine that dependent device is incapable of initiating a connection as requested in message 370. As a result, enabling device may reject the initial request and may commit to initiating the new connection.

In some embodiments, message 372 may include initiation or connection transfer information. For example, message 372 may include a status code 90 and may also include time-to-start information. In various embodiments, the time-to-start information may comprise a time 376 during which enabling device 304 is committing to initiating and/or stabling the second connection (e.g. the TVWS connection). In some embodiments, within the time duration 376, enabling device 304 may send message 374 to dependent device 302. Message 374 may include or comprise the necessary initiation or establishment information for enabling device 304 and dependent device 302 to transfer, using FST, their original WiFi connection to a TVWS connection. Other embodiments are described and claimed.

Operations for various embodiments may be further described with reference to the following figures and accompanying examples. Some of the figures may include a logic flow. It can be appreciated that an illustrated logic flow merely provides one example of how the described functionality may be implemented. Further, a given logic flow does not necessarily have to be executed in the order presented unless otherwise indicated. In addition, a logic flow may be implemented by a hardware element, a software element executed by a processor, or any combination thereof. The embodiments are not limited in this context.

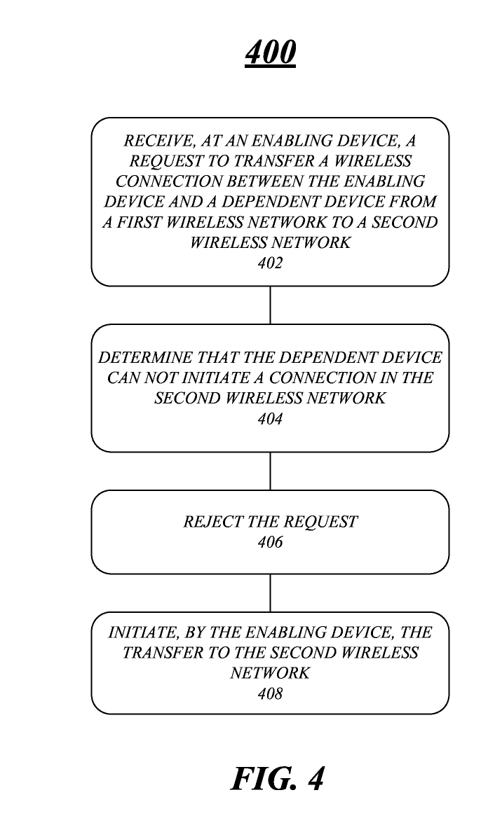

FIG. 4 illustrates embodiments of a logic flow 400 for enabling management of the transfer of a wireless communication connection between wireless networks, channels or bands. In various embodiments, the logic flow 400 may be performed by various systems, nodes, and/or modules and may be implemented as hardware, software, and/or any combination thereof, as desired for a given set of design parameters or performance constraints. For example, the logic flow 400 may be implemented by a logic device (e.g., node, STA, wireless device, base station, enabling device, or mode II device) and/or logic comprising instructions, data, and/or code to be executed by a logic device or processor circuit. For purposes of illustration, and not limitation, the logic flow 400 is described with reference to FIGS. 3A and 3B. The embodiments are not limited in this context.

In various embodiments, as shown in FIG. 4, a request to transfer a wireless connection between the enabling device and a dependent device from a first wireless network to a second wireless network may be received at an enabling device at 402. For example, enabling device 304 may receive a request from dependent device 302 to transfer connection 318 of network 312 to connection 320 of network 314. In some embodiments, the transfer may comprise a transfer from a WiFi connection to a TVWS connection.

At 404, in some embodiments, a determination may be made that the dependent device can not initiate a connection in the second wireless network. For example, enabling device 304 may determine that dependent device 302 is not capable or is not allowed to initiate a TVWS connection. As a result, the request may be rejected at 306. For example, enabling device 304 may inform dependent device 302 that it is not allowed to initiate the requested connection. In some embodiments, enabling device 304 may be operative to send rejection information to the dependent device 302, the rejection information comprising status code information and time-to-start information. In other embodiments, enabling device 304 may additionally or alternatively be operative to send transfer information from to the dependent device 302. In various embodiments, the communications between the enabling device 304 and the dependent device 302 may occur over the first wireless network 312 or connection 318.

In various embodiments, the enabling device may initiate a transfer to the second wireless network at 308. For example, enabling device 304 may commit to initiating and/or establishing a connection between the enabling device 304 and the dependent device 302 over the second wireless network 314 or channel 320. In some embodiments, because dependent device 302 is unable to initiate a TVWS connection, enabling device 302 may take it upon itself to initiate and establish the requested TVWS connection.

The enabling device may be operative to determine its location in some embodiments. For example, enabling device 304 may be equipped with GPS or other location logic that enable the device 304 to determine its geographic location. In various embodiments, enabling device may be operative to identify available channels in the second wireless network based on the location and based a channel database accessed by the enabling device. For example, enabling device 304 may be operative to access one or more databases or servers (e.g. 308, 310) to determine what channels, bands, frequencies or networks are available based on the determined location. In some embodiments, a connection between the enabling device and the dependent device may be established using one or more available channels of the second wireless network. For example, based on the location information and available channel, band, network or frequency information, enabling device 304 may be operative to establish a new connection 320 or new network 314 with dependent device 302. Other embodiments are described and claimed.

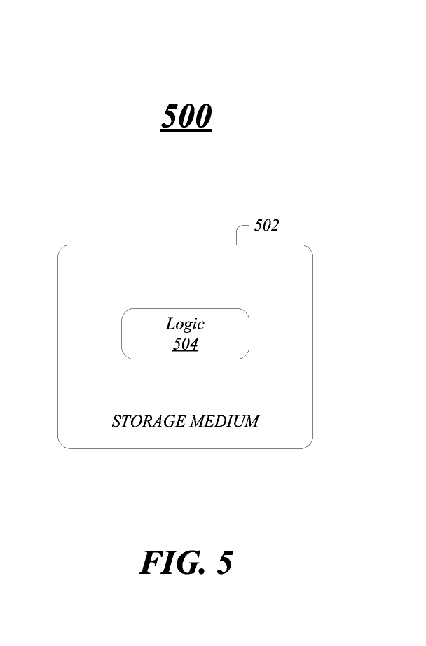

FIG. 5 illustrates one embodiment of an article of manufacture 500. As shown, the article 500 may comprise a storage medium 502 to store logic 504 for managing the transfer of wireless connections in some embodiments. For example, logic 504 may be used to implement a processor circuit for a mobile computing device, enabling device, dependent device, mode I device, mode II device, node or other system, as well as other aspects of nodes 104-1-n, for example. In various embodiments, the article 500 may be implemented by various systems, nodes, and/or modules.

The article 500 and/or machine-readable or computer-readable storage medium 502 may include one or more types of computer-readable storage media capable of storing data, including volatile memory or, non-volatile memory, removable or non-removable memory, erasable or non-erasable memory, writeable or re-writeable memory, and so forth. In some embodiments, the store medium 502 may comprise a non-transitory storage medium. Examples of a machine-readable storage medium may include, without limitation, random-access memory (RAM), dynamic RAM (DRAM), Double-Data-Rate DRAM (DDR-DRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information. Moreover, any media involved with downloading or transferring a computer program from a remote computer to a requesting computer carried by data signals embodied in a carrier wave or other propagation medium through a communication link (e.g., a modem, radio or network connection) is considered computer-readable storage media.

The article 500 and/or machine-readable medium 502 may store logic 504 comprising instructions, data, and/or code that, if executed by a machine, may cause the machine to perform a method and/or operations in accordance with the described embodiments. Such a machine may include, for example, any suitable processing platform, computing platform, computing device, processing device, computing system, processing system, computer, processor, or the like, and may be implemented using any suitable combination of hardware and/or software.

The logic 504 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context. When the logic 504 is implemented as software, any suitable processor and memory unit may execute the software.

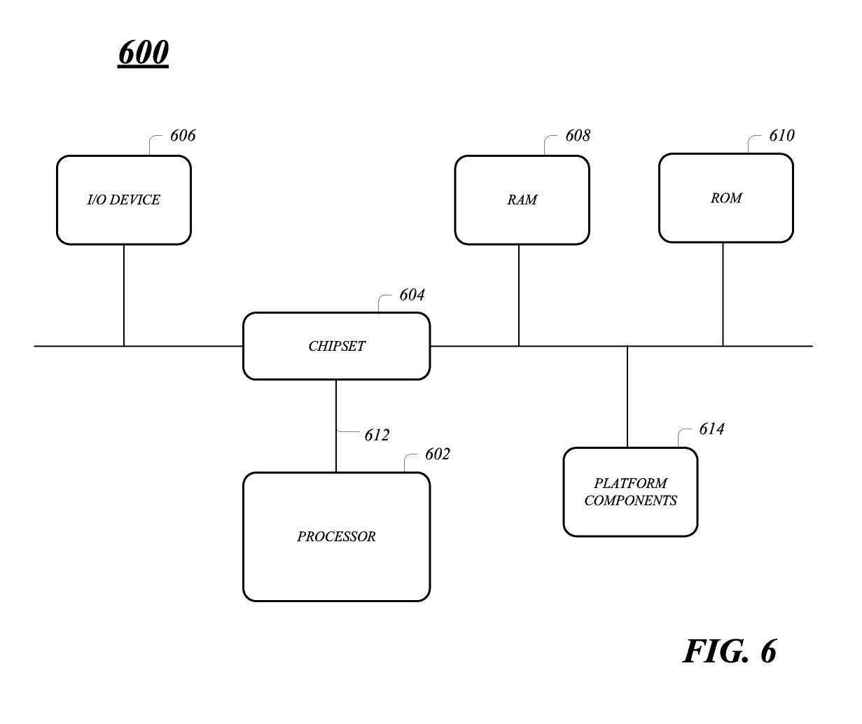

FIG. 6 is a diagram of an exemplary system embodiment. In particular, FIG. 6 is a diagram showing a system 600, which may include various elements. For instance, FIG. 6 shows that system 600 may include a processor 602, a chipset 604, an input/output (I/O) device 606, a random access memory (RAM) (such as dynamic RAM (DRAM)) 608, and a read only memory (ROM) 610, and various platform components 614 (e.g., a fan, a crossflow blower, a heat sink, DTM system, cooling system, housing, vents, and so forth). These elements may be implemented in hardware, software, firmware, or any combination thereof. The embodiments, however, are not limited to these elements.

As shown in FIG. 6, I/O device 606, RAM 608, and ROM 610 are coupled to processor 602 by way of chipset 604. Chipset 604 may be coupled to processor 602 by a bus 612. Accordingly, bus 612 may include multiple lines.

Processor 602 may be a central processing unit comprising one or more processor cores and may include any number of processors having any number of processor cores. The processor 602 may include any type of processing unit, such as, for example, CPU, multi-processing unit, a reduced instruction set computer (RISC), a processor that have a pipeline, a complex instruction set computer (CISC), digital signal processor (DSP), and so forth.

Although not shown, the system 600 may include various interface circuits, such as an Ethernet interface and/or a Universal Serial Bus (USB) interface, and/or the like. In some exemplary embodiments, the I/O device 606 may comprise one or more input devices connected to interface circuits for entering data and commands into the system 600. For example, the input devices may include a keyboard, mouse, touch screen, track pad, track ball, isopoint, a voice recognition system, and/or the like. Similarly, the I/O device 606 may comprise one or more output devices connected to the interface circuits for outputting information to an operator. For example, the output devices may include one or more digital displays, printers, speakers, and/or other output devices, if desired. For example, one of the output devices may be a digital display. The display may be a cathode ray tube (CRTs), liquid crystal displays (LCDs), light emitting diode (LED) display or any other type of display.

The system 600 may also have a wired or wireless network interface to exchange data with other devices via a connection to a network. The network connection may be any type of network connection, such as a wireless connection or a wired connection, including but not limited to a cellular connection, radio frequency connection, an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

The foregoing represent are only a few examples of the problems that may be overcome by implementing a method, system and apparatus to manage or group M2M devices in a wireless communications system, and it may be appreciated that other problems may be overcome and other advantages may exist as well.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable or computer-readable medium or article which may store an instruction, a set of instructions or computer executable code that, if executed by a machine or processor, may cause the machine or processor to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter that lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A method, comprising:
receiving, at an enabling device, a request to transfer a wireless connection between the enabling device and a dependent device from a first wireless network to a second wireless network;
determining that the dependent device can not initiate a connection in the second wireless network;
rejecting the request; and
initiating, by the enabling device, the transfer to the second wireless network.

2. The method of claim 1, comprising:
sending rejection information to the dependent device, the rejection information comprising status code information and time-to-start information.

3. The method of claim 1, comprising:
sending transfer information from the enabling device to the dependent device over the first wireless network.

4. The method of claim 1, comprising:
establishing a connection between the enabling device and the dependent device over the second wireless network.

5. The method of claim 1, comprising:
determining, by the enabling device, a location of the enabling device;
identifying available channels in the second wireless network based on the location and a channel database accessible by the enabling device; and
establishing a connection between the enabling device and the dependent device using one or more available channels of the second wireless network.

6. The method of claim 1, the first wireless network comprising a wireless local area network (WLAN).

7. The method of claim 1, the second wireless network comprising a wireless network operative to utilize one or more frequencies allocated to a broadcasting service that is not used in the area of the enabling device.

8. The method of claim 1, the second wireless network comprising a wireless network operative to utilize television white space (TVWS) frequencies, frequency bands or channels.

9. The method of claim 1, comprising:
utilizing a fast session transfer (FST) protocol to complete the transfer of the wireless connection from the first wireless network to the second wireless network.

10. An article comprising a computer-readable storage medium containing instructions that when executed by a processor enable a system to:
receive, at an enabling device, a request to transfer a wireless connection between the enabling device and a dependent device from a first wireless network to a second wireless network;
determine that the dependent device can not initiate a connection in the second wireless network;
send rejection information to the dependent device, the rejection information comprising status code information or time-to-start information; and
send transfer information from the enabling device to the dependent device over the first wireless network.

11. The article of claim 10, comprising instructions that when executed enable the system to:
initiate, by the enabling device, the transfer to the second wireless network.

12. The article of claim 10, comprising instructions that when executed enable the system to:
establish a connection between the enabling device and the dependent device over the second wireless network.

13. The article of claim 10, comprising instructions that when executed enable the system to:
determine, by the enabling device, a location of the enabling device;
identify available channels in the second wireless network based on the location and a channel database accessed by the enabling device; and
establish a connection between the enabling device and the dependent device using one or more available channels of the second wireless network.

14. The article of claim 10, the first wireless network comprising a wireless local area network (WLAN) and the second wireless network comprising a wireless network operative to utilize television white space (TVWS) frequencies.

15. An apparatus, comprising:
a processor circuit operative to receive a request from a wireless device to transfer a wireless connection between the apparatus and the wireless device from a first wireless network to a second wireless network, determine that the wireless device can not initiate a connection in the second wireless network, reject the request, and initiate the transfer to the second wireless network.

16. The apparatus of claim 15, the processor circuit operative to send rejection information to the wireless device, the rejection information comprising status code information and time-to-start information.

17. The apparatus of claim 15, the processor circuit operative to send transfer information from the apparatus to the wireless device over the first wireless network.

18. The apparatus of claim 15, the processor circuit operative to establish a connection between the apparatus and the wireless device over the second wireless network.

19. The apparatus of claim 15, the processor circuit operative to determine a location of the apparatus, identify available channels in the second wireless network based on the location and a channel database accessible by the apparatus, and establish a connection between the apparatus and the wireless device using one or more available channels of the second wireless network.

20. The apparatus of claim 15, comprising:
one or more radio frequency (RF) transceivers coupled to the processor circuit to send and receive electromagnetic representations of information between the apparatus and the wireless device.

21. The apparatus of claim 15, the first wireless network comprising a wireless local area network (WLAN).

22. The apparatus of claim 15, the second wireless network comprising a wireless network operative to utilize one or more frequencies allocated to a broadcasting service that is not used in the area of the enabling device.

23. The apparatus of claim 15, the second wireless network comprising a wireless network operative to utilize television white space (TVWS) frequencies, frequency bands or channels.

24. The apparatus of claim 15, the processor circuit operative to utilize a fast session transfer (FST) protocol to complete the transfer of the wireless connection from the first wireless network to the second wireless network.

25. The apparatus of claim 15, the apparatus comprising a laptop computer, ultra-laptop computer, portable computer, tablet computer, personal computer (PC), notebook PC, handheld computer, personal digital assistant (PDA), cellular telephone, combination cellular telephone/PDA, or smartphone.

26-31. (canceled)
